(19) United States
(12) Patent Application Publication
(10) Pub. No.: US 2019/0139343 A1
(43) Pub. Date: May 9, 2019

(54) ELECTRONIC LOCK SYSTEM, ELECTRONIC LOCK DEVICE, AND METHOD FOR UNLOCKING ELECTRONIC LOCK DEVICE

(71) Applicant: WFE TECHNOLOGY CORP., Taichung City (TW)

(72) Inventor: Chih-Min LIEN, Taichung City (TW)

(73) Assignee: WFE TECHNOLOGY CORP., Taichung City (TW)

(21) Appl. No.: 15/804,626

(22) Filed: Nov. 6, 2017

(51) Int. Cl. G07C 9/00

(52) U.S. Cl. CPC G07C 9/00309; G07C 2009/00365; G07C 9/00039

(57) ABSTRACT

An electronic lock system includes a server unit and an electronic lock device including a control module and a transmission module. The control module outputs a wakeup signal upon receipt of an input signal. The transmission module is to be awaken to an awaken state from a sleep state upon receipt of the wakeup signal, and outputs a confirm signal based on the input signal. The server unit receives a remote signal containing an unlock condition associated with the confirm signal, and outputs an unlock signal to the control module to cause the electronic lock device to operate in an unlock state upon receipt of the unlock signal when the unlock condition is satisfied.

### FIELD

The disclosure relates to a lock system, more particularly to an electronic lock system, an electronic lock device, and a method for unlocking the electronic lock device.

### BACKGROUND

Locks are security devices used for protecting property, and have evolved from earlier locks, such as cylinder locks or rim locks, to electronic locks of modern time. Since an electronic lock can be unlocked through digital authentication without the use of a physical key, the electronic lock is widely applicable to domestic usage to eliminate the need to physically carry a bunch of keys.

### SUMMARY

Therefore, an object of the disclosure is to provide an electronic lock system and device and a method for unlocking the electronic lock device.

According to the disclosure, the electronic lock system includes an electronic lock device and a server unit. The electronic lock device includes an input module, a control module and a transmission module. The input module is configured to output an input signal in response to a user input. The control module is connected to the input module for receiving the input signal therefrom and is configured to output a wakeup signal upon receipt of the input signal. The transmission module is in a sleep state by default, is connected to the control module for receiving the wakeup signal therefrom, is configured to be awaken to an awaken state upon receipt of the wakeup signal in the sleep state, and is controlled by the control module to output a confirm signal based on the input signal when in the awaken state. The server unit is communicatively connected to the transmission module for receiving the confirm signal therefrom, and is configured to receive a remote signal which contains unlock information associated with an unlock condition from a remote device, and to output an unlock signal to the control module through the transmission module when the unlock condition is satisfied, wherein the unlock condition is associated with the confirm signal. The control module is configured to cause the electronic lock device to operate in an unlock state upon receipt of the unlock signal.

According to another aspect of this disclosure, a method for unlocking an electronic lock device is provided. The electronic lock device is communicatively connected to a server unit that communicates with a remote device, and includes an input module, a transmission module and a control module.

The method includes:

outputting, by the input module, an input signal in response to a user input;

outputting, by the control module, a wakeup signal upon receipt of the input signal;

outputting, by the transmission module which is in asleep state by default, a confirm signal to the server unit after the transmission module is awaken to an awaken state upon receipt of the wakeup signal when in the sleep state;

receiving, by the server unit from the remote device, a remote signal that contains unlock information associated with an unlock condition;

outputting, by the server unit, an unlock signal to the transmission module when the unlock condition is satisfied, wherein the unlock condition is associated with the confirm signal;

causing, by the control module, the electronic lock device to operate in an unlock state upon receipt of the unlock signal; and

initiating, by the server unit, a notification that is associated with the output of the unlock signal.

According to still another aspect of this disclosure, an electronic lock device communicatively connected to a server unit is provided. The server unit has unlock information associated with an unlock condition, and generates an unlock signal when the unlock condition is satisfied. The electronic lock device includes an input module, a control module, and a transmission module. The input module is configured to output an input signal in response to a user input. The control module is connected to the input module for receiving the input signal therefrom, and is configured to output a wakeup signal upon receipt of the input signal. The transmission module is in a sleep state by default, is connected to the control module for receiving the wakeup signal therefrom, is configured to operate in an awaken state upon receipt of the wakeup signal in the sleep state, and is controlled by the control module based on the input signal to output a confirm signal to the server unit in the awaken state. The confirm signal is associated with the unlock condition. The control module is configured to cause the electronic lock device to operate in an unlock state upon receipt of the unlock signal through the transmission module.

### BRIEF DESCRIPTION OF THE DRAWINGS

Other features and advantages of the disclosure will become apparent in the following detailed description of the embodiment (s) with reference to the accompanying drawings, of which:

FIG. 1 is schematic view of the electronic lock system according to an embodiment of this disclosure;

FIG. 2 is a block diagram of the electronic lock system; and

FIG. 3 is a flow chart of a method for unlocking an electronic lock device of the electronic lock system according to an embodiment of this disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

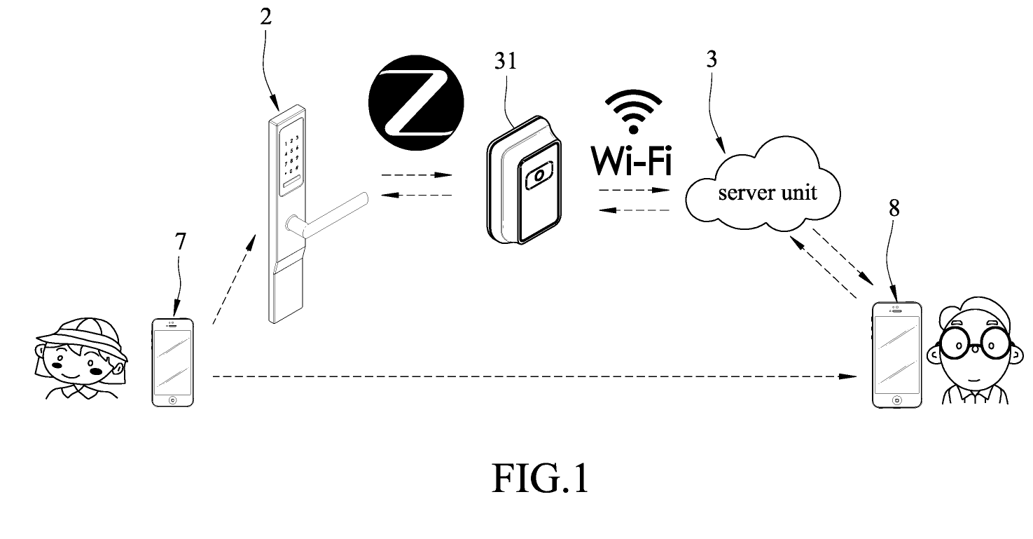

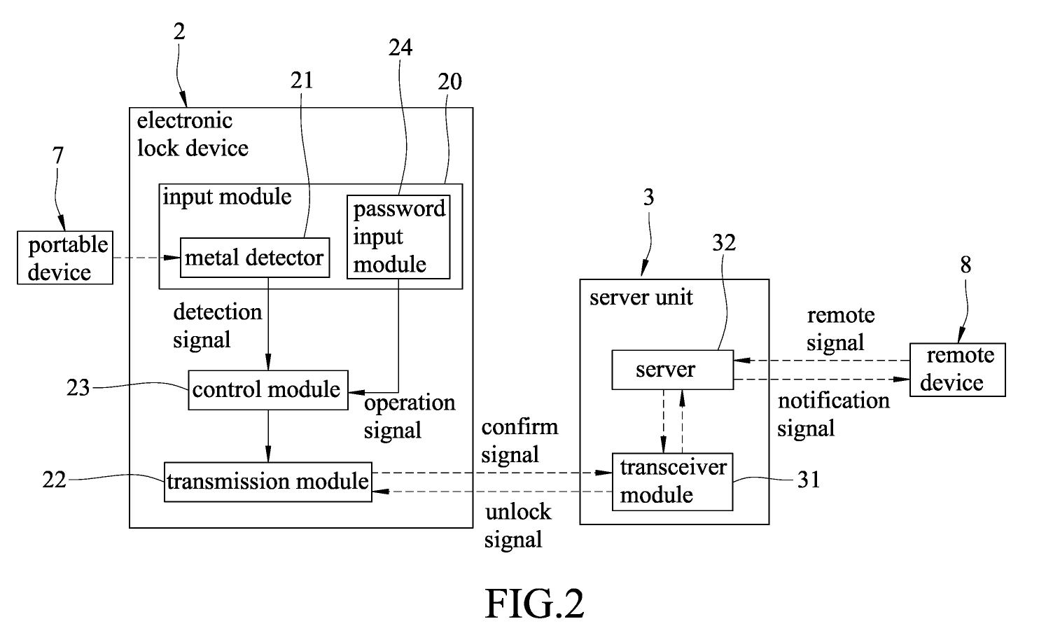

Referring to FIGS. 1 and 2, an electronic lock system includes an electronic lock device 2 and a server unit 3. The electronic lock device 2 includes an input module 20, a control module 23 and a transmission module 22. The input module 20 is configured to output an input signal in response to a user input and includes a metal detector 21 and a password input device 24. The control module 23 is connected to the input module 20 for receiving the input signal therefrom, and is configured to output a wakeup signal upon receipt of the input signal. The transmission module 22 is in a sleep state by default, is connected to the control module 23 for receiving the wakeup signal therefrom, is configured to operate in an awaken state upon receipt of the wakeup signal when in the sleep state, and is controlled by the control module 23 based on the input signal to output a confirm signal when in the awaken state. The server unit 3 is communicatively connected to the transmission module 22 and includes a transceiver module 31 and a server 32. The transceiver module 31 is configured to receive the confirm signal from the transmission module 22. The server 32 communicates with a remote device 8 and relays a remote signal from the remote device 8 to the transceiver module 31. The remote signal contains unlock information associated with an unlock condition, and the unlock condition is associated with the confirm signal.

The metal detector 21 is configured to output a detection signal that serves as the input signal upon detection of a metal component that has a size falling within a specific range. In an embodiment, the control module 23 outputs the wakeup signal to the transmission module 22 for awaking the same, and controls the transmission module 22 that has been awakened to the awaken state to output the confirm signal upon receipt of the input signal originating from the metal detector 21 (i.e., the detection signal). For example, when a portable device 7 is disposed proximate to the metal detector 21, the metal detector 21 detects a size of a metal component of the portable device 7, and outputs the detection signal as the input signal when the detected size of the metal component of the portable device 7 falls within the specific range so as to wake up the transmission module 22 to output the confirm signal. Since the size of a metal component in the portable device 7 is generally quite different from that of other items normally carried by a user, such as keys, coins or watches, the specific range may be so set as to comply with specifications of specific kinds of portable devices (e.g., smartphones), such that other kinds of carried items cannot be used to enable operation of the electronic lock system.

It should be noted that in other embodiments of this disclosure, the metal detector 21 may be replaced by a radio frequency identification (RFID) reader for reading RFID tags, and the control module 23 causes the electronic lock device 2 to operate in an unlock state once the RFID reader receives a reply from a RFID tag that has been authenticated in advance.

The password input device 24 is configured to output an operation signal serving as the input signal when operated by the user, for example, pressed by the user. In an embodiment that the operation signal outputted by the password input device 24 serving as the input signal is received by the control module 23 to awake the transmission module 22, the password input device 24 then receives a password input, e.g., from a user, and transmits the same to the control module 23.

The unlock information contained in the remote signal from the remote device 8 received by the server 32 indicates an unlock time period and/or includes an unlock password which would be transmitted to the control module 23 through the transceiver module 31 and the transmission module 22 when the transmission module 22 is in the awaken state. In the case that the unlock information includes the unlock password, the control module 23 compares the password input received by the password input device 24 with the unlock password, and generates the confirm signal to be received by the transceiver module 31 upon determining that the password input matches the unlock password.

In the case that the unlock information indicates the unlock time period, the transceiver module 31 is configured to output the unlock signal upon receipt of the confirm signal within the unlock time period. Hereafter, the control module 23 causes the electronic lock device 2 to operate in the unlock state upon receipt of the unlock signal.

The transceiver module 31 is further configured to initiate a notification that is associated with the output of the unlock signal. Specifically, the transceiver module 31 may be a doorbell that is capable of audibly outputting a predetermined sound to serve as the notification, and/or transmitting a notification signal to the remote device 8 through the server 32, such that the remote device 8 (e.g., a smartphone) generates a perceivable notification (e.g., displaying a message) to a user of the remote device 8 to notify that the unlock signal has been issued, so the electronic lock device 2 should have been unlocked.

It should be noted that the communication between the transmission module 22 and the transceiver module 31 is implemented by using a wireless transmission technology. For example, the wireless transmission technology is defined by one of a ZigBee specification, a radio frequency technology, a Bluetooth standard, and a Wireless Fidelity (Wi-Fi) technology. In this embodiment, the transmission between the transmission module 22 and the transceiver module 31 exemplarily utilizes ZigBee transmission technology.

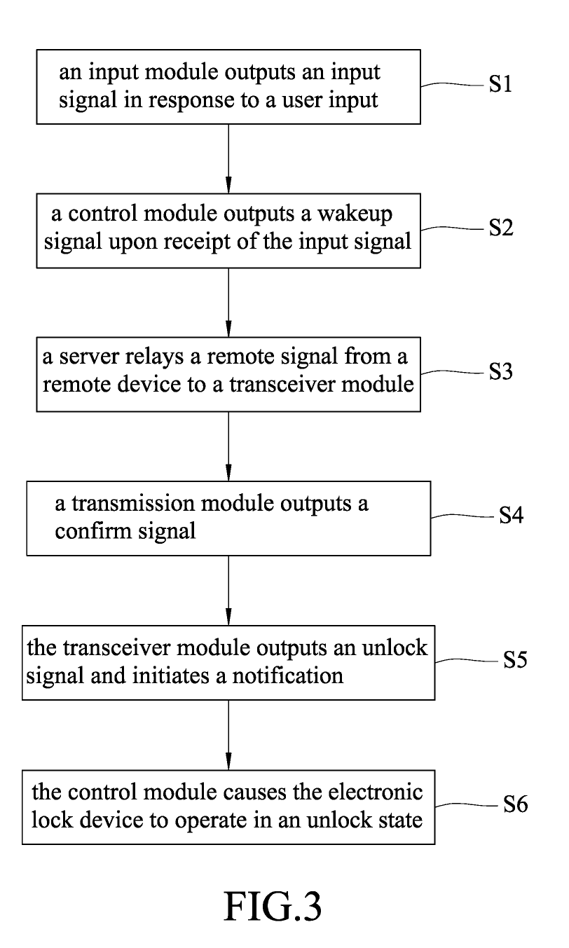

Further referring to FIG. 3, a method for unlocking the electronic lock device 2 is provided, and two implementations thereof will be exemplarily described. In a first implementation, the unlock information indicates an unlock time period. In a second implementation, the unlock information includes an unlock password.

In step S1, the input module 20 outputs an input signal in response to a user input. In the first implementation, a detection signal generated by the metal detector 21 serves as the input signal. In the second implementation, an operation signal generated by the password input device 24 serves as the input signal.

In step S2, the control module 23 outputs a wakeup signal upon receipt of the input signal to awake the transmission module 22 that is in a sleep mode by default to an awaken state.

In step S3, the server 32 relays a remote signal that contains the unlock information associated with an unlock condition from the remote device 8 to the transceiver module 31.

In step S4, the transmission module 22 outputs a confirm signal to the transceiver module 31 as controlled by the control module 23 based on the input signal. In the first implementation, the transmission module 22 directly outputs the confirm signal under control of the control module 23 upon receipt by the control module 23 of the input signal originated from the metal detector 21. In the second implementation, the transceiver module 31 transmits the unlock password to the control module 23 through the transmission module 22 in step S3 and the control module 23 compares a password input from the password input module 24 with the unlock password, and controls the transmission module 22 to output the confirm signal upon determining that the password input matches the unlock password.

In the first implementation, when the transceiver module 31 receives the confirm signal within the unlock time period (the unlock condition associated with the confirm signal is satisfied), the flow goes to step S5, where the transceiver module 31 outputs an unlock signal to the transmission module 22, and/or initiates a notification (e.g., outputting audibly a predetermined sound, transmitting a notification signal to the remote device 8 through the server 32, etc.). In the second implementation, step S5 is directly performed upon receipt of the confirm signal by the transceiver module 31 (the unlock condition, which is associated with the confirm signal and is that the password input matches the unlock password, is satisfied). In other embodiments, the first and second implementations may be combined together, i.e., a password input that matches the unlock password must be inputted within the unlock time period (time for signal transmission is ignored herein) to enable provision of the unlock signal, but this disclosure is not limited in this respect.

After step S5, in step S6, the control module 23 causes the electronic lock device 2 to operate in an unlock state upon receipt of the unlock signal through the transmission module 22.

In an actual implementation, taking a small family utilizing the electronic lock system as an example, the portable device 7 may be a smartphone held by one family member, and the remote device 8 may be another smartphone held by another family member, but this disclosure is not limited in this respect. Generally, an RFID tag in the form of a card is used as a key to unlock the electronic lock device 2 without involvement of the server unit 3. In the case that a child of the family forgets to bring the key, he can contact another family member, e.g., the father, by his smartphone (the portable device 7). The father may operate the remote device 8, which can be a smartphone of the father, to set an unlock time period of, for example, ten minutes, and send a remote signal that contains the unlock time period to the transceiver module 31 via the server 32 when he confirms that the child is waiting by the door, and then tell the child that remote authorization has been completed. Then, within ten minutes from the receipt of the remote signal by the transceiver module 31 (unlock time period), if the child puts his smartphone near the metal detector 21, the control module 23 will directly output the confirm signal. Upon receipt of the confirm signal within the unlock time period, the transceiver module 31 outputs the unlock signal to cause the electronic lock device 2 to operate in the unlock state, i.e., to unlock the door.

In another scenario that the father operates the remote device 8 to set an unlock password and send a remote signal that includes the unlock password to the server 32, which relays the unlock password to the transceiver module 31, the child may press buttons of the password input device 24, which awakes the transmission module 22 and allows for receipt thereby of the unlock password from the transceiver module 31, to input the unlock password conveyed to him by the father.

Upon determining that the inputted password matches the unlock password, the control module 23 controls the transmission module 22 to output the confirm signal. Then, upon receipt of the confirm signal, the transceiver module 31 outputs the unlock signal to enable the control module 23 to unlock the door, and initiates the notification.

To sum up, by virtue of the control module 23, the transmission module 22 and the server unit 3, the unlock signal can be provided to unlock the electronic lock device 2 when the unlock condition associated with the confirm signal is satisfied. Further, a holder of the remote device 8 can be notified by the notification initiated by the transceiver module 31 upon output of the unlock signal. By this way, when any of the family members forgets to bring the key card (RFID tag) or when a visitor arrives before the host, the electronic lock system can be operated to unlock the door as desired for preventing the family member or the visitor from waiting for a longtime. Additionally, the transmission module 22 is in a sleep state by default and is awaken to the awaken state upon receipt of the wakeup signal, thus an energy saving effect can also be provided.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An electronic lock system comprising:
an electronic lock device that includes
an input module configured to output an input signal in response to a user input;
a control module connected to said input module for receiving the input signal therefrom, and configured to output a wakeup signal upon receipt of the input signal; and
a transmission module being in a sleep state by default, connected to said control module for receiving the wakeup signal therefrom, configured to be awaken to an awaken state upon receipt of the wakeup signal when in the sleep state, and controlled by said control module based on the input signal to output a confirm signal when in the awaken state; and
a server unit communicatively connected to said transmission module for receiving the confirm signal therefrom, and configured to receive, from a remote device, a remote signal which contains unlock information associated with an unlock condition, and to output an unlock signal to said control module through said transmission module when the unlock condition is satisfied, wherein the unlock condition is associated with the confirm signal;
said control module being configured to cause said electronic lock device to operate in an unlock state upon receipt of the unlock signal.

2. The electronic lock system as claimed in claim 1, wherein said server unit includes:
a transceiver module configured to receive the confirm signal from said transmission module, to output the unlock signal to said transmission module when the unlock condition is satisfied, and to initiate a notification that is associated with the output of the unlock signal; and
a server configured to relay the remote signal from the remote device to said transceiver module;
wherein the notification is initiated by said transceiver module in at least one of a first manner where said transceiver module audibly outputs a predetermined sound, or a second manner where said transceiver module transmits a notification signal to the remote device through said server.

3. The electronic lock system as claimed in claim 2, wherein said input module includes a password input device configured to output an operation signal that serves as the input signal when operated by the user;
wherein the unlock information includes an unlock password, and said server is further configured to transmit the unlock password to said control module through said transceiver module and said transmission module;
wherein said password input device is configured to receive a password input and transmit the password input to said control module, and said control module is further configured to generate the confirm signal for output by said transmission module upon determining that the password input matches the unlock password; and
wherein said transceiver module is configured to output the unlock signal upon receipt of the confirm signal.

4. The electronic lock system as claimed in claim 2, wherein communication between said transmission module and said transceiver module is implemented by using a wireless transmission technology.

5. The electronic lock system as claimed in claim 4, wherein the wireless transmission technology is defined by one of a ZigBee specification, a radio frequency technology, a Bluetooth standard, and a Wireless Fidelity (Wi-Fi) technology.

6. The electronic lock system as claimed in claim 1, wherein said input module includes a metal detector configured to output a detection signal that serves as the input signal upon detection of a metal component that has a size falling within a specific range.

7. The electronic lock system as claimed in claim 1, wherein the unlock information indicates an unlock time period, and said server unit is configured to output the unlock signal to said transmission module upon receipt of the confirm signal within the unlock time period.

8. The electronic lock system as claimed in claim 7, wherein said input module includes a metal detector configured to output a detection signal that serves as the input signal upon detection of a metal component that has a size falling within a specific range; and
wherein said control module controls said transmission module to output the confirm signal upon receipt of the input signal originating from said metal detector.

9. A method for unlocking an electronic lock device, the electronic lock device communicatively connected to a server unit that communicates with a remote device, the electronic lock device including an input module, a transmission module and a control module, the method comprising:
outputting, by the input module, an input signal in response to a user input;
outputting, by the control module, a wakeup signal upon receipt of the input signal;
outputting, by the transmission module which is in asleep state by default, a confirm signal to the server unit after the transmission module is awaken to an awaken state upon receipt of the wakeup signal when in the sleep state;
receiving, by the server unit from the remote device, a remote signal that contains unlock information associated with an unlock condition;
outputting, by the server unit, an unlock signal to the transmission module when the unlock condition is satisfied, wherein the unlock condition is associated with the confirm signal; and
causing, by the control module, the electronic lock device to operate in an unlock state upon receipt of the unlock signal.

10. The method as claimed in claim 9, the server unit including a transceiver module and a server, wherein the outputting the unlock signal includes:
relaying, by the server, the remote signal from the remote device to the transceiver module;
receiving, by the transceiver module, the confirm signal from the transmission module; and
outputting, by the transceiver module, the unlock signal to the transmission module when the unlock condition is satisfied;
said method further comprising: initiating, by the server unit, a notification that is associated with the output of the unlock signal, wherein the initiating the notification includes at least one of a step of outputting audibly a predetermined sound by the transceiver module, and a step of transmitting a notification signal to the remote device through the server.

11. The method as claimed in claim 10, the input module including a password input device, wherein the outputting the input signal includes: outputting, by the password input device, an operation signal that serves as the input signal when pressed by the user;
wherein the unlock information includes an unlock password, and the outputting the unlock signal includes:
transmitting, by the server, the unlock password to the control module through the transceiver module and the transmission module;
receiving, by the password input device, a password input and transmitting the password input to the control module;
generating, by the control module, the confirm signal for output by the transmission module upon determining that the password input matches the unlock password; and
outputting, by the transceiver module, the unlock signal upon receipt of the confirm signal.

12. The method as claimed in claim 9, the input module including a metal detector, the outputting the input signal includes:
outputting, by the metal detector, a detection signal that serves as the input signal upon detection of a metal component that has a size falling within a specific range.

13. The method as claimed in claim 9, wherein the unlock information indicates an unlock time period, and the outputting the unlock signal includes:
outputting, by the server unit, the unlock signal to the transmission module upon receipt of the confirm signal from the transmission module within the unlock time period.

14. The method as claimed in claim 13, the input module including a metal detector, the outputting the input signal includes:
outputting, by the metal detector, a detection signal that serves as the input signal upon detection of a metal component that has a size falling within a specific range; and
controlling, by the control module, the transmission module to output the confirm signal upon receipt of the input signal originating from the metal detector.

15. An electronic lock device communicatively connected to a server unit that has unlock information associated with an unlock condition, and that generates an unlock signal when the unlock condition is satisfied, said electronic lock device comprising:
an input module configured to output an input signal in response to a user input;
a control module connected to said input module for receiving the input signal therefrom, and configured to output a wakeup signal upon receipt of the input signal; and
a transmission module being in a sleep state by default, connected to said control module for receiving the wakeup signal therefrom, disposed to be communicatively connected to the server unit for receiving the unlock signal therefrom, configured to be awaken to an awaken state upon receipt of the wakeup signal when in the sleep state, and controlled by said control module based on the input signal to output a confirm signal to the server unit when in the awaken state, the confirm signal being associated with the unlock condition;
said control module being configured to cause said electronic lock device to operate in an unlock state upon receipt of the unlock signal through said transmission module.

16. The electronic lock device as claimed in claim 15, the unlock information including an unlock password, and the server unit generating the unlock signal upon receipt of the confirm signal;
wherein said input module includes a password input device configured to output an operation signal that serves as the input signal when operated by the user;
wherein said control module is configured to receive the unlock password from the server unit through said transmission module;
wherein said password input device is configured to receive a password input and transmit the password input to said control module, and said control module is further configured to generate the confirm signal for output by said transmission module upon determining that the password input matches the unlock password.

17. The electronic lock device as claimed in claim 15, wherein communication between said transmission module and the server unit is implemented by using a wireless transmission technology defined by one of a ZigBee specification, a radio frequency technology, a Bluetooth standard, and a Wireless Fidelity (Wi-Fi) technology.

18. The electronic lock device as claimed in claim 15, wherein said input module includes a metal detector configured to output a detection signal that serves as the input signal upon detection of a metal component that has a size falling within a specific range.

19. The electronic lock system as claimed in claim 18, wherein said control module controls said transmission module to output the confirm signal upon receipt of the input signal originating from said metal detector.
